(19) United States
(12) Patent Application Publication
(10) Pub. No.: US 2026/0156458 A1
(43) Pub. Date: Jun. 4, 2026

(54) CASUAL KEY MOBILE EDGE COMMUNICATION

(71) Applicant: INTERNATIONAL BUSINESS MACHINES CORPORATION, ARMONK, NY (US)

(72) Inventors: Kishore Saravanan, Chennai (IN); Subhajit Bhuiya, BENGALURU (IN); Vijay Ekambaram, Chennai (IN)

(21) Appl. No.: 18/966,436

(22) Filed: Dec. 3, 2024

(51) Int. Cl. H04W 12/03; H04W 12/04

(52) U.S. Cl. CPC H04W 12/03; H04W 12/04

(57) ABSTRACT

One or more computer processors indexing one or more communications between a sending device and a receiving device. The one or more computer processors generate a casual key based on the one or more indexed communications, wherein the casual key is an encryption key. The one or more computer processors encrypt a subsequent communication with the generated casual key. The one or more computer processors create a payload comprising the encrypted communication. The one or more computer processors broadcast the payload.

### BACKGROUND

The invention relates generally to the field of mobile communication, and more particularly to mobile edge communication.

Ultrasonic data transmission uses a simple combination of sound, software, and existing device hardware to create a seamless, reliable, secure, cost-effective, and energy-efficient approach to connectivity and always-on communication. Data can be transmission ultrasonically by a converting each character into the center of a corresponding frequency range, and transmitting that frequency for a certain duration. A receiving side performs a continuous Fourier transform of the signal and looks for peaks in the specified frequency range. Upon finding a peak for a significant duration, the receiving side performs a conversion back from frequency to character.

### SUMMARY

Embodiments of the invention disclose a computer-implemented method, a computer program product, and a system. The computer-implemented method includes one or more computer processers indexing one or more communications between a sending device and a receiving device. The one or more computer processors generate a casual key based on the one or more indexed communications, wherein the casual key is an encryption key. The one or more computer processors encrypt a subsequent communication with the generated casual key. The one or more computer processors create a payload comprising the encrypted communication. The one or more computer processors broadcast the payload.

### BRIEF DESCRIPTION OF THE DRAWINGS

FIG. 1 is a functional block diagram illustrating a computing environment, in accordance with an embodiment of the invention;

FIG. 2 is a flowchart depicting operational steps of a program, on a computer within the computing environment of FIG. 1, for secure casual key mobile communication, in accordance with an embodiment of the invention; and

FIG. 3 illustrates an exemplary embodiment of the program within the computing environment of FIG. 1, in accordance with an embodiment of the invention.

### DETAILED DESCRIPTION

Effective mobile connectivity can become constrained due to a plurality of contributing factors such as geographical obstacles, data infrastructure difficulties, geopolitical disputes, and technological incapabilities between different devices or standards. For example, regional data communication can be greatly diminished when a power outage affects cellular infrastructure. In this example, peer to peer or edge mobile communication can assist with communication gaps caused by the aforementioned contributing factors. In many cases, near field communication can be implemented and utilized to facilitate communication, although data security issues may arise. For example, where mobile devices are not able to access internet, mobile devices are able to communicate or transmit data utilizing ultrasonic methods, however, this broadcasting method cannot be targeted to a single device and will broadcast to every capable device within a physical vicinity of the transmitting device. If the data is not encrypted, every receiving device will be able to read the data, thus compromising data security. Some methods of encryption use fixed key, but fixed key requires that an intended receiving device has prior access to a decryption key. In the examples discussed above, it would be impossible to securely transmit a fixed key without a possibility of unintended recipients also receiving the fixed key.

Embodiments of the invention facilitate secure local communications without a prerequisite transfer of encryption keys between peers. Embodiments of the invention generate an encryption/decryption key (i.e., casual keys) on the fly (e.g., at the time of transmission) utilizing data common to both a sending device and a receiving device. Embodiments of the invention identify files or notifications common to a sender and receiver and utilize said commonalities to seed encryption/decryption key generation. Embodiments of the invention broadcast data encrypted by a casual key through ultrasonic methods (e.g., ultrasound frequency splits) to a localized receiving device. In these embodiments, generated encryption and decryption keys are not shared from a sending device to a receiving device. Embodiments of the present invention recognize that discovering casual keys across pairs of devices based on common files stored in the devices identified through extended notifications allows for secure data encoding, decoding, and transmission between the sender and receiver. Implementation of embodiments of the invention may take a variety of forms, and exemplary implementation details are discussed subsequently with reference to the Figures.

The invention will now be described in detail with reference to the figures.

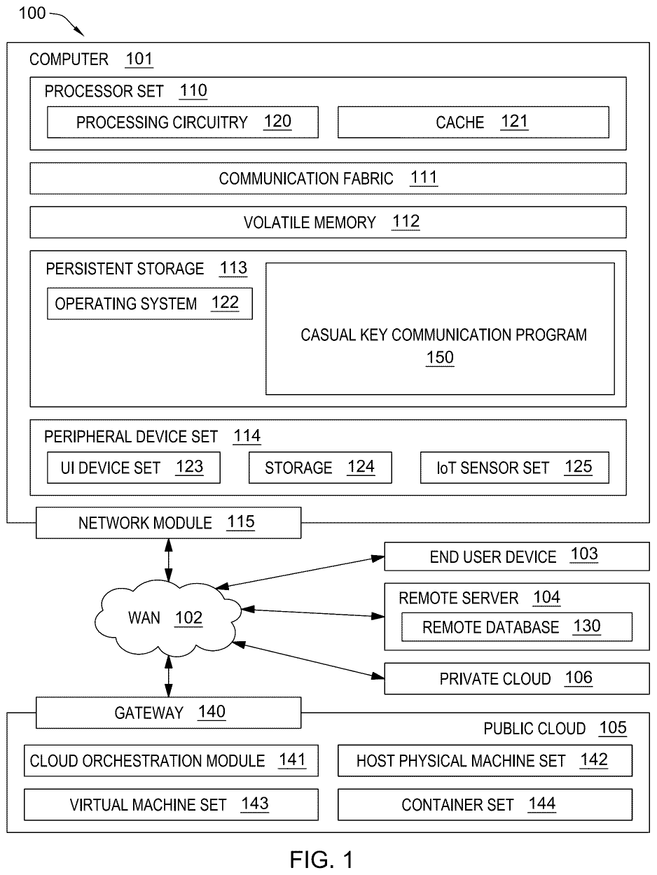

FIG. 1 depicts computing environment 100 illustrating components of computer 101 in accordance with an illustrative embodiment of the invention. It should be appreciated that FIG. 1 provides only an illustration of one implementation and does not imply any limitations with regard to the environments in which different embodiments may be implemented. Many modifications to the depicted environment may be made.

Various aspects of the disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, defragmentation, or garbage collection, but this does not render the storage device as transitory because the data is not transitory while it is stored.

Computing environment 100 contains an example of an environment for the execution of at least some of the computer code involved in performing the inventive methods, such as casual key communication program 150, hereinafter referred to as program 150. In addition to program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip”. In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in program 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

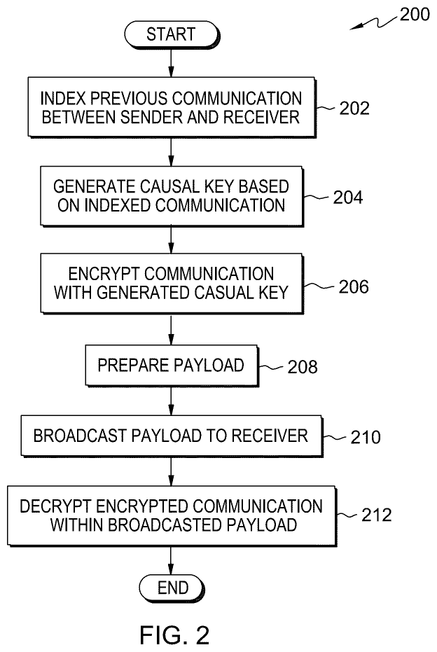

Program 150 is a program, a subprogram of a larger program, an application, a plurality of applications, or mobile application software, which functions to facilitate secure communication through mobile casual keys. In various embodiments, program 150 may implement the following steps: index one or more communications between a sending device and a receiving device; generate a casual key based on the one or more indexed communications, wherein the casual key is an encryption key; encrypt a subsequent communication with the generated casual key; create a payload comprising the encrypted communication; and broadcast the payload. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over WAN 102. In various embodiments, client versions of program 150 resides on any other computing device (not depicted) within computing environment 100. Program 150 is depicted and described in further detail with respect to FIG. 2.

Embodiments of the invention may contain various accessible data sources, such as a database (e.g., remote database 130), that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Program 150 may provide informed consent, with notice of the collection of personal data, allowing the user to opt in or opt out of processing personal data. Consent can take several forms: opt-in consent imposes on the user to take an affirmative action before the personal data is processed, alternatively, opt-out consent imposes on the user to take an affirmative action to prevent the processing of personal data before the data is processed. Program 150 enables the authorized and secure processing of user information, such as tracking information, as well as personal data, such as personally identifying information or sensitive personal information. Program 150 may provide information regarding the personal data and the nature (e.g., type, scope, purpose, duration) of the processing. Program 150 may provide the user with copies of stored personal data. Program 150 may allow the correction or completion of incorrect or incomplete personal data. Program 150 may allow the immediate deletion of personal data.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

FIG. 2 depicts flowchart 200 illustrating operational steps of program 150 for secure casual key mobile communication, in accordance with an embodiment of the invention.

Program 150 indexes previous communication between a sender and a receiver (step 202). In an embodiment, program 150 initiates responsive to one or more communications (e.g., transmitted files, shared notifications, voice chats, video chats, voice messages, transmitted textual (e.g., emails, short message service) or graphical messages (e.g., emojis, pictures, videos) between a sending device and a receiving device. In another embodiment, program 150 initiates responsive to a request for encryption, decryption, or transmission of data from a sending device or receiving device. In an embodiment, responsive to one or more communications between a sending device and receiving device, program 150 creates a unique index for each communication along with an association to the message contents and a timestamp. For example, program 150 indexes a transmitted social media direct message to a user of a receiving device. In another embodiment, program 150 adds a location field associated with a physical location of the sending device. In another embodiment, responsive to a picture or video transmission, program 150 utilizes object recognition to identify one or more objects within the picture or video transmission and responsively attaches the one or more identified objects to a corresponding index. Responsively, both devices (i.e., sending and receiving) create an index associated with the transmitted social media direct message. In another embodiment, responsive to a voice or video call, program 150 records a duration of the call and associates the duration to a corresponding index.

In an embodiment, responsive to a first time communication between two users (e.g., devices), at least one of the users (e.g., user A) creates a universally unique identifier (UUID) associated with the other user (e.g., user B). This UUID is stored within a device associated with the UUID creator (e.g., user A) against the other user (e.g., user B). In an embodiment, responsive to the created UUID, the UUID creator transmits the UUID to the other user or a device associated with the other user, responsively program 150 responds with an acknowledgement of the transmitted UUID from the device associated with the other user. In another embodiment, as the two users continue to transmit subsequent communications, program 150 associates the subsequent communications (e.g., communication contents, duration, identified objects, identified users within the communication, timestamp, location, communication method) to the shared UUID stored on both devices. In an embodiment, program 150 monitors one or more communication applications (e.g., text messaging application) or platforms (e.g., social media platform) associated with the users or devices. In another embodiment, program 150 monitors one or more system notifications associated with the transmitted or received communications.

Program generates a casual key based on indexed communication (step 204). In an embodiment, responsive to a user or application attempt or indication of an intent to encrypt a data transmission for another user or device, program 150 generates a casual key based on previously indexed communication. In this embodiment, program 150 generates the casual key such that the key is discoverable by an intended recipient and not any other user or device that may receive a communication encrypted by the generated casual key. In an embodiment, program 150 utilizes the indexed and shared communications between two users/devices as a seed (e.g., randomly created sequence of characters) to generate a unique encryption key (i.e., casual key) on the fly. For example, program 150 concatenates a subset of shared communications and utilizing a binary representation of the concatenation as an encryption or decryption seed. In example, program 150 utilizes a bitwise operation on the binary representation as an encryption or decryption seed.

In an embodiment, program 150 determines a casual key function (i.e., key generation scheme identifier) that delineates which indexed information will be utilized to create a casual key. For example, program 150 utilizes all or a subset of communications between two users to create a seed to generate the casual key. In another example, program 150 utilizes a most recent attachment in an exchanged email between the users to create a seed to generate the casual key. In yet another example, program 150 utilizes an entire or subset of calls or call duration to create seed to generate the casual key. In an embodiment, program 150 utilizes a subset of communications within a timeframe utilizing timestamps associated the communications. In an embodiment, program 150 utilizes one or more objects identified within an image or video in a previous communication to generate the casual key. For example, program 150 utilizes one or more identified objects represented in binary as a seed for the generation of the casual key. In another embodiment, the casual key function is user defined or randomly selected from a plurality of casual key functions.

In an embodiment, program 150 dynamically determines a casual key function based on behavioral analysis (e.g., analyzes user communication patterns for predictable sequences) of at least one user in the communication. In an embodiment, program 150 conducts behavioral analysis after each new communication. In an embodiment, program 150 maintains a priority list of casual key functions where unpredictable (e.g., irregular) communications are ranked higher than predictable communications. For example, a user may send attachments with an amount of data (e.g., more than 50 kilobytes), a user may typically write lengthy chat messages (e.g., spanning over 200 words), and a user may contact other users in a predictable call pattern (e.g., a call every morning or every other day). In an example, a user has a predictable pattern of phone calls consisting of the user initiating a call to another user for 2-3 minutes and then transmitting a text message. In this example, program 150 determines that a casual key created with said predicable communication pattern might be detectable by an unintended recipient, responsively program 150 eliminates a corresponding casual key function that utilizes the predictable communication pattern. Program 150 may analyze user behavior to select a suitable method (i.e., unpredictable casual key function) to generate the casual key such that the casual key and underlying seed is not detectable by untended recipients. In an embodiment, program 150 utilizes a last attachment that was communicated between two users for casual key generation. In another embodiment, program 150 utilizes content within a subset of communication (e.g., text messages, emails) to generate a casual key. In another embodiment, program 150 utilizes a subset of phone calls between the users (e.g., last 2 phone calls, specifically timestamps and duration of calls) to generate a casual key. In an example, a user transmits a common attachment (e.g., graphical signature) in numerous communications with another user, responsively program 150 eliminates utilizing said attachment within a casual key function. In this example, program 150 selects an unpredictable casual key function, such as content or metadata associated with irregularly transmitted communications.

Program 150 encrypts a communication with the generated casual key (step 206). In an embodiment, program 150 encrypts the intended data transmission (e.g., communication) for an intended recipient utilizing the generated casual key from step 204. Program 150 may scramble the communication based on the generated casual key.

Program 150 prepares a message payload (step 208). In an embodiment, responsive to an encrypted message, communication, or data, program 150 creates a payload for data transmission to an intended recipient. In an embodiment, program 150 utilizes a first set of bytes (bytes 1-16) to encode the UUID or index of the intended recipient. In another embodiment, program 150 utilizes a next set of bytes (i.e., byte 17-18) to encode a key generation scheme identifier (i.e., casual key function), as detailed in step 204. In yet another embodiment, program 150 utilizes a next set of bytes (byte 19-34) to encode one or more timestamps associated with communication indicated in the casual key function. For example, responsive to the associated key generation scheme identifier, program 150 may include two timestamps associated with two indexed communications; a timestamp and call duration associated with an indexed phone call; or assigned null if a timestamp or duration is not required by the key generation scheme identifier. In yet another embodiment, program 150 utilizes a next set of bytes (byte 35-36) to encode a communication type associated with the key generation scheme identifier. In yet another embodiment, program 150 utilizes a next set of bytes (byte 37-52) to encode a communication identifier (e.g., message id). In an embodiment, program 150 utilizes the remaining set of bytes to encode the communication encrypted by the casual key as detailed in steps 204 and 206.

Program 150 broadcasts the payload to the receiver (step 210). In an embodiment, program 150 broadcasts the created payload from step 208 to an intended recipient. For example, program 150 utilizes ultrasound split transmissions to deliver the payload to any available device within a transmission radius, where the payload is transmitted utilizing a plurality of split ultrasonic frequencies. In another embodiment, program 150 utilizes local wireless networks to transmit the payload to an intended recipient. In yet another embodiment, program 150 utilizes radio waves to transmit the payload.

Program 150 decrypts the encrypted message within the broadcasted payload (step 212). In an embodiment, program 150 receives a broadcasted payload on one or more devices associated with the intended recipient. In another embodiment, responsive to the received payload, program 150 checks the 1^{st} 16 bytes of the payload for a UUID corresponding to the intended recipient. If program 150 matches the transmitted UUID 1^{st} 16 bytes with the intended recipient, then program 150 reads the next set of bytes to identify the key generation scheme (i.e., casual key function). Responsively, program 150 may continue to read the payload to identify any transmitted timestamps, call durations, message type and message identifiers. In an embodiment, program 150 utilizes the read information to retrieve previous communications between the sending device and receiving device and generates a casual key, as detailed in step 204, according to the received casual key function. In another embodiment, program 150 utilizes the generated casual key to decrypt the encrypted communication contained in the payload. Program 150 may display the decrypted communication to a user of the receiving device. In an embodiment, broadcasted communications are not utilized for subsequent casual key generation.

In an embodiment, responsive to a receiving device being unable to identify or retrieve historical communications required by the casual key function, program 150 transmits a response (e.g., missing event notification) back to the sending device for an additional casual key generation and retransmission of the payload. Responsive to a sender receiving a missing event notification from a receiving device, program 150 generates a new casual key with a different casual key function, encrypts the communication, adjusts the payload accordingly, and broadcasts the adjusted payload. Responsive to the receiver failing to decode the encryption a second time, program 150 halts any response and eliminates any stored payloads. Responsive to a successful decryption, program 150 may respond with an acknowledgement message utilizing the same message identifier contained in the payload, where the acknowledgement message is encrypted utilizing the same casual key as the sender or utilizing a newly generated casual key along with a corresponding casual key function. In an embodiment, if the sending device does not receive an acknowledge response within a predetermined timeframe, program 150 marks the message as not received and presents the user with a graphical option within a user interface to retransmit or halt communication.

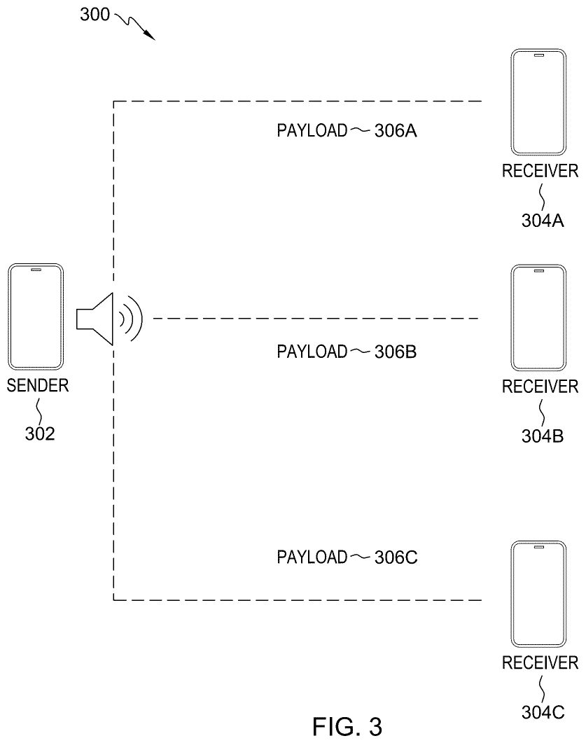

FIG. 3 depicts exemplary embodiment 300, in accordance with an illustrative embodiment of the invention. Exemplary embodiment 300 contains sender 302, a device with historical communications with a plurality of receivers (e.g., receiver 304A, receiver 304B, and receiver 304C); payload 306A, 306B, and 306C, a plurality of payloads, each specifically created to a different receiver based on respective historical communication; and receiver 304A, receiver 304B, and receiver 304C, a plurality of intended recipients of payload 306A, 306B, and 306C, respectively. Sender 302 utilizes historical conservations between the receivers to create payload 306A, 306B, and 306C that each contain communications encrypted by created casual keys specific to each receiver and their communications to sender 302A. Sender 302 creates payload 306A intended for receiver 304A, payload 306B intended for receiver 304B, and payload 306C intended for receiver 304C; each payload is created utilizing a casual key function specific to each respective receiver and based on respective historical communication between sender 302 and each respective receiver. Responsive to payload creation, sender 302 broadcasts the payload, via ultrasonic methods, to any device within an ultrasonic vicinity. Despite unintended recipients receiving the payload, payload contents are safe from unauthorized access due to casual key generation on the sender and receiver devices, where devices without access to the historical communications utilized to generate the casual key are unable to decrypt communication within the received payload.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
indexing one or more communications between a sending device and a receiving device;
generating a casual key based on the one or more indexed communications, wherein the casual key is an encryption key;
encrypting a subsequent communication with the generated casual key;
creating a payload comprising the encrypted communication; and
broadcasting the payload.

2. The computer-implemented method of claim 1, wherein generating the casual key based on the indexed one or more communications, comprises:
determining a casual key function delineating a subset of indexed communication that is utilized to generate the casual key.

3. The computer-implemented method of claim 1, wherein the payload comprises a universally unique identifier, a casual key function, an associated timestamp, a communication type, a communication identifier, and the encrypted subsequent communication.

4. The computer-implemented method of claim 2, further comprising:
dynamically determining the casual key function based on behavioral analysis of a user associated with the sending device.

5. The computer-implemented method of claim 2, further comprising:
responsive to a communication containing an image, identifying one or more objects within the image; and
generating the casual key utilizing the one or more identified objects.

6. The computer-implemented method of claim 1, wherein broadcasting the payload, comprises:
broadcasting the payload utilizing ultrasonic split frequencies.

7. The computer-implemented method of claim 1, further comprising:
responsive to a first communication between the sending device and the receiving device, creating a universally unique identifier associated with the receiving device; and
transmitting the universally unique identifier to the receiving device.

8. A computer program product comprising:
one or more computer readable storage media having computer-readable program instructions stored on the one or more computer readable storage media, said program instructions executes a computer-implemented method comprising steps of:
indexing one or more communications between a sending device and a receiving device;
generating a casual key based on the one or more indexed communications, wherein the casual key is an encryption key;
encrypting a subsequent communication with the generated casual key;
creating a payload comprising the encrypted communication; and
broadcasting the payload.

9. The computer program product of claim 8, wherein the program instructions to generate the casual key based on the indexed one or more communications, stored on the one or more computer readable storage media, comprise the steps of:
determining a casual key function delineating a subset of indexed communication that is utilized to generate the casual key.

10. The computer program product of claim 8, wherein the payload comprises a universally unique identifier, a casual key function, an associated timestamp, a communication type, a communication identifier, and the encrypted subsequent communication.

11. The computer program product of claim 9, wherein the program instructions, stored on the one or more computer readable storage media, further comprise the steps of:
dynamically determining the casual key function based on behavioral analysis of a user associated with the sending device.

12. The computer program product of claim 9, wherein the program instructions, stored on the one or more computer readable storage media, further comprise the steps of:
responsive to a communication containing an image, identifying one or more objects within the image; and
generating the casual key utilizing the one or more identified objects.

13. The computer program product of claim 8, wherein the program instructions to broadcast the payload, stored on the one or more computer readable storage media, comprise the steps of:
broadcasting the payload utilizing ultrasonic split frequencies.

14. The computer program product of claim 8, wherein the program instructions, stored on the one or more computer readable storage media, further comprise the steps of:
responsive to a first communication between the sending device and the receiving device, creating a universally unique identifier associated with the receiving device; and
transmitting the universally unique identifier to the receiving device.

15. A computer system comprising:
one or more computer processors;
one or more computer readable storage media having computer readable program instructions stored on the one or more computer readable storage media for execution by at least one of the one or more processors, the stored program instructions execute a computer-implemented method comprising steps of:
indexing one or more communications between a sending device and a receiving device;
generating a casual key based on the one or more indexed communications, wherein the casual key is an encryption key;
encrypting a subsequent communication with the generated casual key;
creating a payload comprising the encrypted communication; and
broadcasting the payload.

16. The computer system of claim 15, wherein the program instructions to generate the casual key based on the indexed one or more communications, stored on the one or more computer readable storage media, comprise the steps of:
determining a casual key function delineating a subset of indexed communication that is utilized to generate the casual key.

17. The computer system of claim 15, wherein the payload comprises a universally unique identifier, a casual key function, an associated timestamp, a communication type, a communication identifier, and the encrypted subsequent communication.

18. The computer system of claim 16, wherein the program instructions stored on the one or more computer readable storage media, further comprise the steps of:
dynamically determining the casual key function based on behavioral analysis of a user associated with the sending device.

19. The computer system of claim 16, wherein the program instructions stored on the one or more computer readable storage media, further comprise the steps of:
responsive to a communication containing an image, identifying one or more objects within the image; and
generating the casual key utilizing the one or more identified objects.

20. The computer system of claim 15, wherein the program instructions to broadcast the payload, stored on the one or more computer readable storage media, comprise the steps of:
broadcasting the payload utilizing ultrasonic split frequencies.
